(19) United States
(12) Patent Application Publication
(10) Pub. No.: US 2019/0129251 A1
(43) Pub. Date: May 2, 2019

(54) LIGHTING DEVICE AND IMAGE DISPLAY DEVICE

(71) Applicant: SHARP KABUSHIKI KAISHA, Sakai City (JP)

(72) Inventors: HISASHI WATANABE, Sakai City (JP); HIROTOSHI YASUNAGA, Sakai City (JP); YOUZOU KYOUKANE, Sakai City (JP)

(21) Appl. No.: 16/173,673

(22) Filed: Oct. 29, 2018

(30) Foreign Application Priority Data
Oct. 30, 2017 (JP) 2017-209034

(51) Int. Cl. G02F 1/1335; G02B 5/02; G02B 27/09; G02F 1/35

(52) U.S. Cl. CPC G02F 1/133606; G02B 5/0205; G02F 2001/3505; G02F 1/3501; G02F 1/133504; G02B 27/0977

(57) ABSTRACT

The present invention provides a lighting device including a light source and an ink layer configured to transmit and reflect light from the light source. The ink layer contains a white pigment as a first pigment and a second pigment that gives a blue hue to the light passed therethrough.

### CROSS REFERENCE TO RELATED APPLICATION

This application claims priority from Japanese Patent Application No. 2017-209034 filed on Oct. 30, 2017. The entire contents of the priority application are incorporated herein by reference.

### TECHNICAL FIELD

The present invention relates to a lighting device and an image display device.

### BACKGROUND

An image display device such as a liquid crystal display device that includes a non-light emitting display panel requires a lighting device such as a backlight device in addition to a display panel. Backlight devices are broadly divided into direct-lit backlight devices and edge-lit backlight devices according to the location of the light sources. In the direct-lit backlight device, the light source is located directly below the image display surface of the display panel. In the edge-lit backlight device, the light sources are located around the edge of the display panel.

The image display device has been required to provide higher-quality images, and thus a high dynamic range (HDR) technique has attracted attention. In a liquid crystal display device that displays an HDR image, local dimming control is required to locally control the brightness level of the backlight device. The direct-lit backlight device is advantageously used for the local dimming control, but the direct-lit backlight is likely to have a large thickness because light from the light source needs to be diffused for uniform lighting. Japanese Unexamined Patent Application Publication No. 2000-162411 describes a technology to reduce the thickness of the direct-lit backlight device. In the technology, light from the light source is diffused by the white ink layer located on the rear surface of the light-transmitting plate of the direct-lit backlight device.

As described in Japanese Unexamined Patent Application Publication No. 2000-162411, the white ink layer is disposed to diffuse the light. The white ink layer includes a white pigment formed of titanium oxide, for example, and a binder in which the white pigment is dispersed. The white ink layer allows the light passed through the ink layer to become more yellowish and the light reflected by the ink layer to become blueish due to the light scattering characteristics of the white pigment. Thus, the light that exits through a portion above the light source, i.e., the light passed through the white ink layer, becomes yellowish, making a difference in hue between portions of the lighting device. The difference is observed as chromaticity variation. In Japanese Unexamined Patent Application Publication No. 2000-162411, a mixture of titanium oxide and barium sulfate is used to reduce the chromaticity variation, but the effect is insufficient.

### SUMMARY

The technology described herein was made in view of the above circumstances. An object is to provide a lighting device and a display device in which chromaticity variation is effectively reduced.

A lighting device according to the technology described herein includes a light source and an ink layer configured to transmit and reflect light from the light source. The ink layer contains a white pigment as a first pigment and a second pigment that gives a blue hue to the light passed therethrough.

The pigment is in the powder form and selectively absorbs or scatters light having a predetermined wavelength to change the color of reflected or transmitted light into a predetermined color.

The ink layer according to the technology described herein includes the white pigment as the first pigment. Examples of the white pigment include titanium oxide, barium sulfate, and zinc oxide. The titanium oxide is preferably used because the ink layer is able to be thinner due to the high reflectance and the high opacity provided by the titanium oxide. As described above, transmitted light passed through the ink layer is likely to become yellowish due to the light scattering characteristic of the white pigment. The inventors of the present invention have conducted an intensive study and found that the chromaticity (hue) of the transmitted light is reliably corrected to be substantially achromatic when the ink layer includes a pigment (second pigment) that provides a blue hue to the transmitted light, in addition to the white pigment. Thus, the uneven brightness of the light emitted by the lighting device is eliminated. Examples of the second pigment used in this technology includes a blue pigment and a pearl pigment (one example of a pigment that includes a light-transmitting core coated with a light-transmitting coating, the coating having a refractive index different from that of the core and being formed of a metal compound). The pearl pigment is preferably used because the light use efficiency is kept high.

The ink layer according to the technology described herein may be disposed on a light-transmitting plate that transmits the light from the light source, e.g., on a diffusing plate that diffuses the light from the light source and allows the light to exit therefrom to the side away from the light source.

The back-lit lighting device, which is advantageous in the local dimming control, has less chromaticity variation when including the lighting device having the above-described configuration. Thus, an image display device including the back-lit lighting device is capable of providing an HDR image and having a smaller thickness.

The technology described herein reduces chromaticity variation in the light output from the lighting device and thus is able to provide an image display device that provides a higher-quality image, for example, by using an HDR technique and has a smaller thickness.

### BRIEF DESCRIPTION OF THE DRAWINGS

FIG. 1 is an exploded perspective view illustrating a liquid crystal display device (image display device) according to an embodiment.

FIG. 2 is a schematic view illustrating a planar configuration of a backlight device (lighting device).

FIG. 3 is a schematic view illustrating a cross-sectional configuration of the backlight device taken along line III-III in FIG. 2. In FIG. 3, some of the light from an LED (light source) passes through an ink layer and some of the light is reflected by the ink layer.

FIG. 4 is a graph indicating transmittance distribution in each of the ink layers of the Sample 1 and the Comparative Samples 1 and 2.

FIG. 5 is a graph indicating reflectance distribution in each of the ink layers of the Samples 1 and 2 and the Comparative Samples 1 and 2.

FIG. 6 is a chromaticity diagram indicating chromaticity of the light passed through or reflected by the ink layers of the Samples 1 and 2 and the Comparative Samples 1 and 2.

FIG. 7 a graph indicating transmittance distribution in each of the ink layers of the Samples 3 to 5 and the Comparative Sample 1.

FIG. 8 is a graph indicating reflectance distribution in each of the ink layers of the Samples 3 to 5 and the Comparative Sample 1.

FIG. 9 is a chromaticity diagram indicating chromaticity of the light passed through or reflected by the ink layers of the Samples 3 to 5 and the Comparative Sample 1.

### DETAILED DESCRIPTION

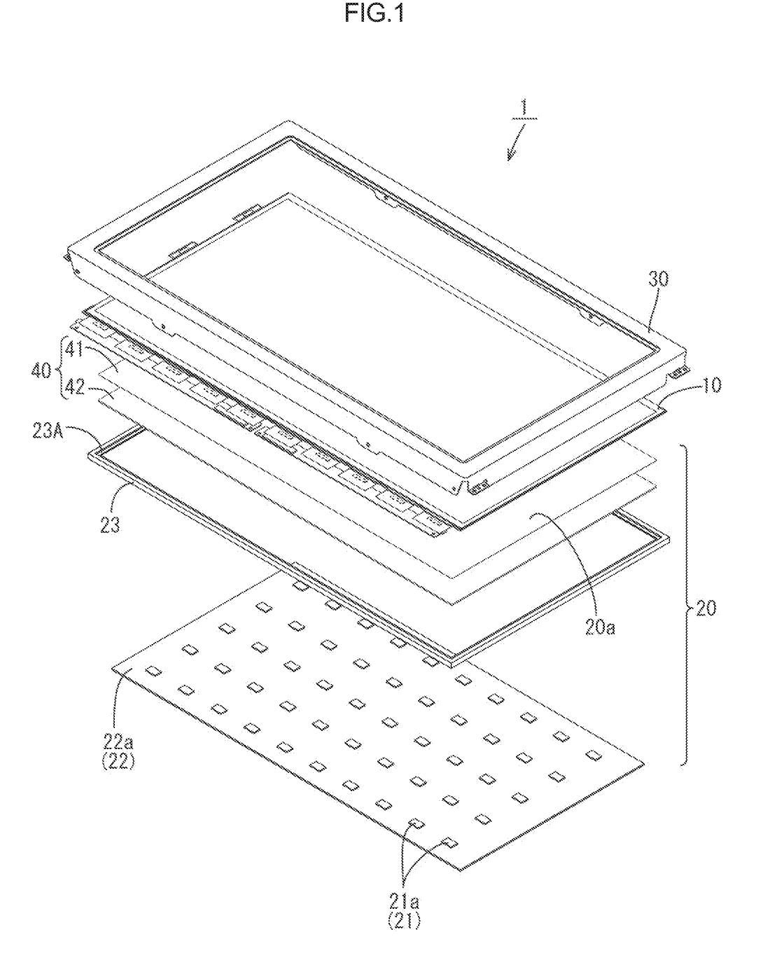

An embodiment is described with reference to FIG. 1 to FIG. 3.

In this embodiment, a backlight device (lighting device) 20, which is a component of a liquid crystal display device (image display device) 1 and attached to a liquid crystal panel (display panel) 10, is described as an example. In the following description, the upper side in FIG. 1 is referred to as an upper side (the lower side is referred to as a lower side). For the identical components, one of them may be designated with a reference numeral and the reference numeral for the other may be omitted.

The liquid crystal display device 1 according to the embodiment is suitable for a display device having a medium to large (or very large) size and requiring a higher-quality image, which may be used in a notebook computer (such as a tablet computer) or a television receiver, for example. However, the application of the technology described herein is not limited to the above and the liquid crystal display device may be used as a display device having a screen size of about a few inches to a dozen inches, which is categorized as a small size or a small to medium size, for example.

As illustrated in FIG. 1, the liquid crystal device 1 has an oblong shape in plan view and includes a liquid crystal panel 10, which is a display panel configured to display an image thereon, and a backlight device 20, which is an external light source configured to apply light to the liquid crystal panel 10 to provide a display. The liquid crystal panel 10 and the backlight device 20 are integrated by a bezel 30 having a frame-like shape, for example. An upper surface of the liquid crystal display device 1 in FIG. 1 is an image display surface on which an image is displayed.

The liquid crystal panel 10 may have any known structure. For example, the liquid crystal panel 10 may include two oblong glass substrates including an array substrate (active matrix substrate) and a CF substrate (counter substrata). The two substrates are bonded together with a predetermined gap therebetween and liquid crystals are sealed therebetween. On the array substrate, switching devices (for example, TFTs) connected to source lines and gate lines, which are disposed perpendicular to each other, pixel electrodes connected to the switching devices, and an alignment film, for example, are disposed. On the CF substrate, a color filter including coloring portions, such as R (red), G (green), and B (blue) coloring portions arranged in a predetermined arrangement, counter electrodes, and an alignment film, for example, are disposed. A polarizing plate is disposed on an outer surface of each glass substrate.

Hereinafter, with reference to FIGS. 1 to 3, the structure of the backlight device 20 is described.

As illustrated in FIG. 1, the backlight device 20 includes top-emitting LEDs 21, which are light sources, an oblong planar LED board 22 having the LEDs 21 thereon, an optical member 40 including multiple oblong members over the LED board 22, and an oblong frame-shaped frame 23 extending along the outer edges of the LED board 22 and the optical member 40. The optical member 40 covers the opening of the frame 23 and is located under the liquid crystal panel 10. The LEDs 21 are dotted over the entire surface of the LED board 22 facing the lower surface of the optical member 40. In other words, the backlight device 20 of the embodiment is a direct-lit backlight device. In the liquid crystal display device 1, the LEDs 21 of the backlight device 20 of this type are positioned directly below the image display surface of the liquid crystal panel 10 and light-emitting surfaces 21a thereof face the liquid crystal panel 10.

The components of the backlight device 20 are described in sequence.

The LEDs 21 used as light sources in the embodiment are mounted on the surface of the LED board 22. The LED 21 is a top-emitting LED having the light-emitting surface 21a facing the side opposite the LED board 22. The LED 21 has an optical axis extending in a normal direction with respect to the image display surface of the liquid crystal panel 10 (normal direction with respect to the surface of the optical member 40). The “optical axis” herein is a line extending from the LED 21 in a traveling direction of light having the highest (peak) emission intensity. The LED 21 is a general-purpose white LED and includes a blue LED device (blue light-emitting device, blue LED chip), which is a light emitting source. The blue LED device is sealed in a case with a sealing material containing phosphors that emit red and green. The white LED may integrally include single color LEDs of red, green, and blue LEDs, for example.

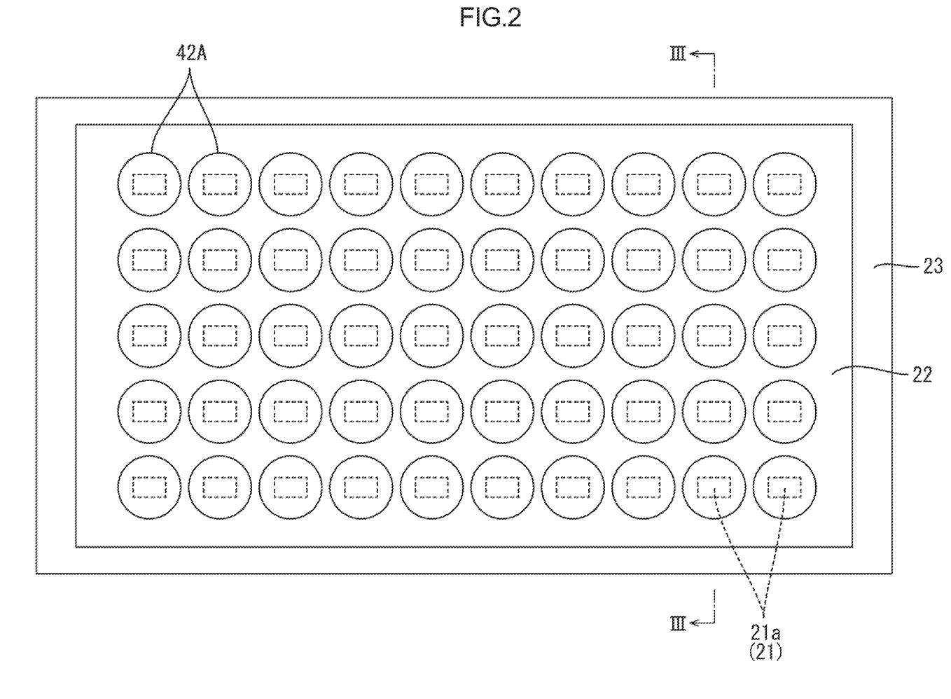

In this embodiment, the LED board 22 has an oblong planar shape and is formed of metal, such as aluminum. The LED board 22 has wiring pattern (not illustrated) formed of a metal film, such as a copper foil, on its surface with an insulating layer therebetween. Alternatively, the LED board 22 may include an insulating board, such as a glass-reinforced epoxy board or a ceramic board, as a base. The upper surface of the LED board 22 (adjacent to the optical member 40) on which the LEDs 21 are mounted is a mounting surface 22a. The LEDs 21 are arranged in rows and columns (in a matrix, in a grid) on the mounting surface 22a of the LED board 22 and are electrically connected to each other by the wiring pattern routed on the mounting surface 22a. Specifically described, as illustrated in FIG. 2, on the mounting surface 22a of the LED board 22, each row include five LEDs 21 arranged in the short-side direction and each column include ten LEDs 21 arranged in the long-side direction. In FIG. 2, which is a schematic view illustrating a planar configuration of the backlight device 20, a prism sheet 41 and a diffusing plate 42, which are upper-side components of the backlight device 20, are not illustrated for ease of understanding. FIG. 2 illustrates the LED board 22, the LEDs 21 on the LED board 22, and the frame 23 and an ink layer 42A positioned above the LED board 22. The arrangement pitch between the LEDs 21 is constant and the LEDs 21 are arranged at an equal interval. The ink layer 42A on the lower surface of the optical member 40 covering the opening of the frame 23 faces the LEDs 21, which are arranged as above, with a predetermined space therebetween. The LED board 22 has a connector to which a cable (not illustrated), for example, is connected. The cable, for example, allows the LED board 22 to be connected to an external power source that supplies driving power to the LED board 22. The wiring pattern on the LED board 22 may have any configuration but is preferably configured to apply a controlled current from an LED driving board (light source driving board), for example, to the LEDs 21. In this embodiment, the mounting surface 22a of the LED board 22 includes a reflective layer (not illustrated) having a white color, which has high light reflectivity, as the top layer.

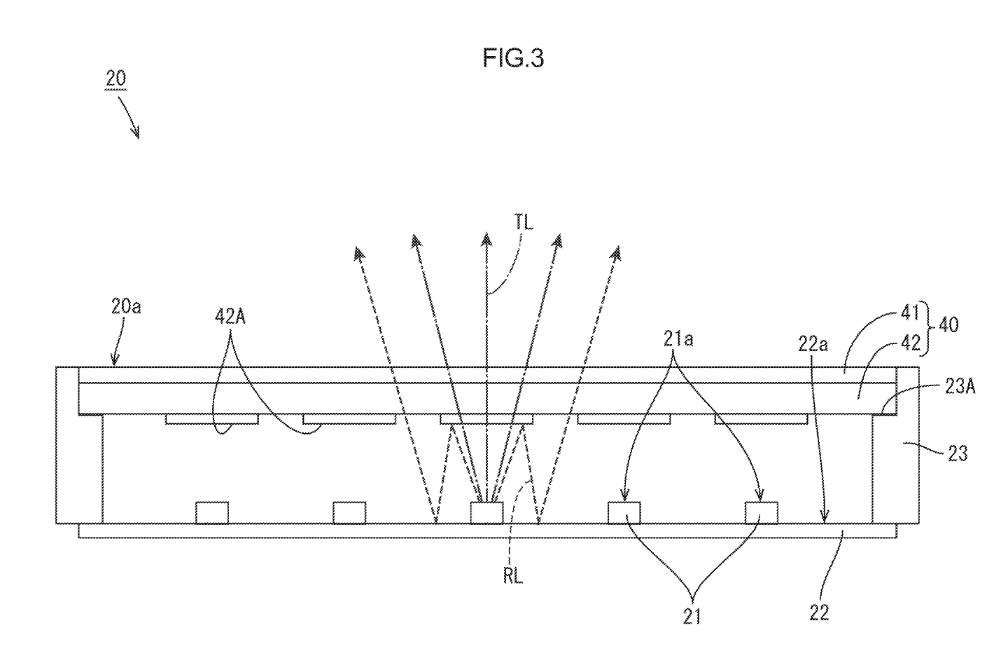

The frame 23 may be a resin injection molded article, for example. The resin is preferably a highly reflective resin. In this embodiment, the frame 23 is formed of a white polycarbonate resin. As illustrated in FIG. 1, the frame 23 has a frame-like shape extending along the outer edges of the LED board 22 and the optical member 40. As illustrated in FIG. 3, the frame 23 has a receiving portion 23A, which is a step-like portion, at the upper inner section. The outer peripheral portion of the LED board 22 is fixed to the lower surface of the frame 23 and the outer peripheral portion of the optical member 40 is placed on the receiving portion 23A. This allows the light emitting surfaces 21a of the LEDs 21 on the LED board 22 to face the optical member 40 with a predetermined space therebetween.

As illustrated in FIG. 1, for example, the optical member 40 has an oblong shape in plan view, which is the same shape as the liquid crystal panel 10 and the LED board 22. The optical member 40 is disposed between the liquid crystal panel 10 and the LEDs 21. The optical member 40 is disposed over the LEDs 21, which are mounted on the LED board 22 with the light emitting surfaces 21a facing upward, i.e., disposed on a light exiting side, with a predetermined space therebetween. In this embodiment, the optical member 40 includes the prism sheet 41 as an upper layer (adjacent to the liquid crystal panel 10, the light exiting side) and the diffusing plate (light-transmitting plate) 42 as a lower layer (adjacent to the LEDs 21, side opposite the light exiting side).

The prism sheet 41 is one type of optical sheets configured to provide predetermined optical effects to light from the LEDs 21. The prism sheet 41 improves brightness of the backlight device 20. The prism sheet 41 may include unit prisms having an apex angle of 90 degrees. The unit prisms may extend in a first direction and may be arranged in a second direction perpendicular to the first side, with no space therebetween. The prism sheet 41 having such a configuration selectively focuses light in the second direction (arrangement direction in which the unit prisms are arranged, direction perpendicular to the extending direction of the unit prism) (anisotropic light focusing effect). In this embodiment, BEF (registered trademark) available from 3M Company is used as the prism sheet 41.

The above-described prism sheet may include multiple prism sheets stacked on top of another. In products that can accept relatively small vertical and horizontal viewing angles, such as smartphones and notebook computers, the two prism sheets are usually stacked with the extending directions of the unit prisms perpendicular to each other. This effectively improves the brightness of the display. In products that can accept relatively small vertical viewing angle, but not small horizontal viewing angle, such as a television receiver and an in-vehicle display device, for example, one prism sheet is usually disposed with the ridge line extending in the horizontal direction. This allows only the horizontal viewing angle to be wider and allows light in the vertical direction to be focused, improving the brightness of the display. In this embodiment, the number of prism sheets is one. The backlight device 20 is not limited to the configuration including the prism sheet 41 and may include a different optical sheet, such as a microlens sheet and a polarizing reflective sheet, instead of or in addition to the prism sheet. In this embodiment, the upper surface of the prism sheet 41 is the light exiting surface 20a through which the light exits from the backlight device 20 toward the liquid crystal panel 10 (FIG. 1 and FIG. 3).

The diffusing plate 42 is one type of light-transmitting plate configured to transmit light. The diffusing plate 42 includes a substantially transparent resin base having a predetermined thickness and diffusing particles dispersed in the base. The light applied into the diffusing plate 42 through the lower surface (adjacent to the LEDs 21) is diffused in the diffusing plate 42 and exits through the upper surface (in a direction away from the LEDs 21). The diffusing plate 42 makes the intensity of light from the light sources uniform before the light exits the diffusing plate 42. Examples of the resin forming the base include, but are not limited to, a (meth)acrylic resin, a polycarbonate resin, a polystyrene resin, and a polyvinyl chloride resin. Preferable examples of the resin forming the base include an acrylic resin and a polycarbonate resin, which provide high transparency and high impact resistance to the base. In this embodiment, SUMIPEX (registered trademark) opal plate available from Sumitomo Chemical Co., Ltd is used as the diffusing plate 42.

In this embodiment, the ink layer 42A is disposed on the lower surface of the diffusing plate 42. The ink layer 42A is described with reference to FIG. 2 and FIG. 3.

As illustrated in FIG. 3, the ink layer 42A in this embodiment includes multiple ink layer pieces 42A on the lower surface of the diffusing plate 42.

As illustrated in FIG. 2, for example, the ink layer 42A preferably includes at least two ink layer pieces 42A disposed directly above the LEDs 21. The ink layer 42A may be disposed over other portions in addition to the portions above the LEDs 21 to further improve uniformity of the outgoing light. The ink layer pieces 42A each having a predetermined shape form a predetermined planer pattern, for example. Examples of the predetermined shape include a circular shape, an elliptical shape, and a cloud-like shape, which are defined by curved lines, a polygonal shape such as a triangular shape and a rectangular shape, which is defined by straight lines, and combination thereof. The ink layer pieces 42A may have the same shape. Alternatively, the shape of the ink layer pieces 42A may be different from each other or may have different sizes (for example, gradation) depending on the arrangement of the ink layer pieces on the diffusing plate 42. Alternatively, the ink layer 42A may have a net-like shape extending continuously over the LEDs 21, for example. In this embodiment, as illustrated in FIG. 2 and FIG. 3, the ink layer 42A includes the disc-shaped ink layer pieces 42A covering the corresponding light emitting surfaces 21a of the LEDs 21 in plan view. All the ink layer pieces 42A have the same shape and the same size.

As illustrated in FIG. 3, the ink layer 42A in this embodiment has the uniform thickness. However, the ink layer 42A may have a nonuniform thickness. The ink layer pieces 42A may have different thicknesses depending on the positions on the diffusing plate 42. Alternatively, the ink layer pieces 42A each may have a nonuniform thickness with a thicker central portion, for example.

The ink layer 42A may be formed on the diffusing plate 42 by any method. For example, the ink layer 42A may be formed by a printing technique such as an inkjet technique and a silkscreen printing technique or a photographic processing including exposure and development processes.

The material of the ink layer 42A is described below.

The ink material contains a pigment as an essential component and a binder in which the pigment is dispersed. The ink material has a different composition depending on the formation technique of the ink layer 42A. The binder may include an evaporation drying resin, an emulsion polymerization resin, or any other reactive resin, for example. The ink material may include an additive, such as a dispersant and a curing agent, in addition to the first and second pigments described later, within a range that does not adversely affect the first and second pigments.

The ink material in this embodiment contains a white pigment as the first pigment.

Examples of the white pigment include titanium oxide (refractive index of 2.50 to 2.72), barium sulfate (refractive index of 1.64), and zinc oxide (refractive index of 2.00). The reflectance and opacity of the pigment generally increase as the difference between the refractive index of the pigment and the refractive index of the binder in which the pigment is dispersed increases. In view of the above, titanium oxide having a high refractive index is preferably used as the white pigment. Titanium oxide is not limited by its origin and the production method, for example. The ink material in this embodiment contains titanium dioxide (TiO₂), which has a high whiteness level, as the white pigment. The ink material may contain another white pigment, such as barium sulfate and zinc oxide, in addition to the titanium oxide.

The ink material in this embodiment contains, in addition to the first pigment, the second pigment that gives a blue hue to the transmitted light.

The second pigment may be a blue pigment. The blue pigment has a blue color and may be a natural or synthetic ultramarine pigment or a natural or synthetic verdigris pigment, for example.

In the preparation of the ink material of this embodiment, a blue ink material containing a blue pigment is added to a white ink material containing titanium oxide, for example, and then, the mixture is stirred.

Alternatively, the second pigment may be a pigment that causes artificial multi-layer reflection, which is represented by pearlescence, to reflect or transmit light having a predetermined wavelength by a light interference phenomenon. Typical examples of such pigment include pearl pigments. The pearl pigment includes a core formed of mica, silicon dioxide (SiO₂), or alumina (Al₂O₃), for example, and coated with a coating formed of a metal compound, such as titanium oxide. Such pigment uses the color of the transmitted light to have optical effects, and thus the core is required to be a light-transmitting core. The metal compound is also required to be a light-transmitting metal compound for the same reason. The metal compound is preferably a metal oxide. The thickness of the metal compound coating is changed to control the interference color of the pigment.

This technology described herein preferably uses one of the pigments that provides a blue hue to the transmitted light, more preferably uses one that provides a blue hue to the transmitted light and a yellow hue to the reflected light. An example of such a pigment is a mica core coated with a titanium oxide coating having a thickness of 30 nm or more and 80 nm or less.

The second pigment preferably has a particle diameter of 1 μm or more and 50 μm or less. The second pigment having a particle diameter larger than the above range may cause clogging in the screen mask during screen printing, for example, leading to lower printing performance. The second pigment having a particle diameter smaller than the above range may reduce the interference effect because of the particle diameter close to the wavelength of light.

In the preparation of the ink material of this embodiment, a pearl pigment is added to an ink material containing titanium oxide, for example, and then the mixture is stirred.

The light passing through the above-described backlight device 20 is described below.

As illustrated in FIG. 3, some of the light from the top surface of the LED 21 passes through the ink layer 42A and then passes through the diffusing plate 42 and the prism sheet 41 in this order. Then, the light exits the backlight device 20 through the light exit surface 20a toward the upper side (the liquid crystal panel 10). Hereinafter, such light is referred to as transmitted light TL. In FIG. 3, the transmitted light TL is indicated by one-dot chain lines. Some of the light from the LED 21 is reflected by the ink layer 42A and then reflected by the reflective layer of the LED board 22, for example. Then, the light enters the diffusing plate 42 through a section without the ink layer 42A. Then, the reflected light passes through the diffusing plate 42 and the prism sheet 41 and exits the backlight device 20 through the light exit surface 20a toward the upper side (the liquid crystal panel 10). Some of the light reflected by the ink layer 42A may be applied to the ink layer 42A again. Hereinafter, the light reflected by the ink layer 42A is referred to as reflected light RL. In FIG. 3, the reflected light RL is indicated by dotted lines.

If the ink layer 42A contains only titanium oxide, for example, the transmitted light TL traveling through the ink layer 42A toward the liquid crystal panel 10 would be yellowish due to light scattering characteristics of the titanium oxide. In contrast, the reflected light RL traveling toward the liquid crystal panel 10 without passing through the ink layer 42A is slightly more bluish than the transmitted light TL. Thus, when the backlight device 20 is viewed from the side of the light exit surface 20a in plan view, the outgoing light is more yellowish at portions corresponding to the ink layer pieces 42A, which are disposed over the LEDs 21, than at the other portions, leading to chromaticity variation in the light exit surface 20a.

To solve the problem, in the backlight device (lighting device) 20 of this embodiment, which includes the LEDs (light sources) 21, the diffusing plate (light-transmitting plate) 42 configured to transmit light from the LEDs 21, and the ink layer 42A disposed on the diffusing plate 42 and configured to transmit and reflect the light from the LEDs 21, the ink layer 42A contains the white pigment including titanium oxide (first pigment) and the pigment that gives a blue hue to the transmitted light, such as a blue pigment and a pearl pigment (second pigment).

This configuration provides the yellow hue and the blue hue in mixture to the transmitted light TL, reducing the yellow hue of the transmitted light TL. The light transmitted through the ink layer 42A has the suitably corrected hue and is substantially achromatic. The difference in hue between the transmitted light TL and the reflection light RL is reduced, reducing the chromaticity variation in the light exit surface 20a of the backlight device 20.

In the configuration of the embodiment, the ink layer 42A is disposed on the diffusing plate 42 configured to diffuse the light from the LEDs 21 and allow the light to exit therefrom toward the side away from the LEDs 21. The diffusing plate 42 in the backlight device 20 uniforms the light from the LED 21, and thus the light exit surface 20a has uniform brightness. The ink layer 42A may be disposed on a light-transmitting plate that transmits the light from the LED 21, for example, but is preferably disposed on the diffusing plate 42 having the above-described function, because such a configuration eliminates the need for a base on which the ink layer 42A is disposed. This reduces the number of components and the cost and simplifies the structure of the backlight device.

In the embodiment, the second pigment may be a blue pigment. The ink layer 42A containing the blue pigment allows the chromaticity of the transmitted light TL passing through the ink layer 42A to be corrected, reducing chromaticity variation in the light exit surface 20a.

Alternatively, the second pigment may be a pigment including a light-transmitting core coated with a light-transmitting coating formed of a metal compound. In the technology described herein, a pigment that gives a blue hue to the transmitted light is preferably used, and a pigment that gives a blue hue to the transmitted light and a yellow hue to the reflected light is more preferably used. Such a pigment is able to cause artificial multi-layer reflection, which is represented by pearlescence, to reflect or transmit light having a predetermined wavelength by a light interference phenomenon. The ink layer 42A containing the pigment allows the chromaticity of the transmitted light TL passing through the ink layer 42A to be corrected, reducing the chromaticity variation in the light-exit surface 20a.

The metal compound coating of the second pigment may have a thickness of 30 nm or more and 80 nm or less. For example, the second pigment includes a mica core coated with a titanium oxide coating having a thickness of 30 nm or more and 80 nm or less. This allows the light passed through the second pigment to be bluish and the reflected light to be yellowish. The employment of such a second pigment more reliably corrects the chromaticity.

The second pigment may have a particle diameter of 1 μm or more and 50 μm or less. The second pigment having a particle diameter in this range does not lower the formation efficiency of the ink layer and efficiently corrects the chromaticity.

In this embodiment, the liquid crystal display device (image display device) 1 includes the backlight device 20 in which chromaticity variation is reduced. The backlight device 20 according to the embodiment is a direct-lit backlight device, which is advantageous in local-dimming control. Thus, the liquid crystal display device 1 capable of providing a higher-quality image, i.e., an HDR image, and having a smaller size is obtained.

### OTHER EMBODIMENTS

The technology disclosed herein is not limited to the embodiment described above and with reference to the drawings. The following embodiments may be included in the technical scope.

(1) The technology described herein is preferably used in a direct-lit backlight device but may be applicable to an edge-lit backlight device.

(2) The technology is applicable to any lighting device including any light source but is more advantageous when applied to a backlight device including a light source with high directivity. In particular, LEDs are widely used in backlight devices and other lighting devices for its low-power consumption, long service life, and small size. However, the LED is likely to have brightness unevenness and chromaticity variation because of its high directivity. The above-described technology is preferably applied to a lighting device including such LEDs as light sources.

(3) The technology is applicable not only to the lighting device for a liquid crystal display device but also to a lighting device for an image display device including a non-light-emitting display panel, which requires a reduction in chromaticity variation in the light exit surface.

Samples

Hereinafter, the technology is described further in detail with reference to the examples. The technology is not limited to the examples described below.

### Example 1

Preparation of Ink Material IM-E1

To “EG-671 white” available from Teikoku Printing Inks Mfg. Co., Ltd, which is a white ink material containing titanium oxide (white pigment, one example of the first pigment), 1% by weight of “EG-037 ultramarine” available from Teikoku Printing Inks Mfg. Co., Ltd, which is a blue ink material containing a blue pigment (one example of the second pigment), was added. Then, the ink materials were mixed to prepare the ink material IM-E1 of the Sample 1.

Production of Light-Transmitting Plate Sample S-E1

The ink material IM-E1 was applied to a surface of a clear and colorless acrylic board by using a screen-printing technique to form an ink layer having a thickness of about 10 μm. Thus, a light-transmitting plate example S-E1 was obtained.

Production of Backlight Device BL-E1

The ink material IM-E1 was applied to a surface of a SUMIPEX (registered trademark) opal plate, which is a light diffusing plate, available from Sumitomo Chemical Co., Ltd. by a screen-printing technique to form the diffusing plate 42 having the disc-like ink layer pieces 42A each having a thickness of about 10 μm directly above the LEDs 21. The diffusing plate 42 and the prism sheet 41 including “BEF” (registered trademark) available from 3M Company were used as the optical member 40 to produce the backlight device 20 described in the first embodiment. The backlight device 20 is used as the backlight device BL-E1 of the Sample 1.

<Sample 2>

Preparation of Ink Material IM-E2

The ink material IM-E2 of the Sample 2 was prepared in the same way as the ink material IM-E1 of the Sample 1, except that the amount of the blue ink material (“EG-037 ultramarine” available from Teikoku Printing Inks Mfg. Co., Ltd) was changed to 3% by weight.

Production of Light-Transmitting Plate Sample S-E2 and Backlight Device BL-E2

The light-transmitting plate example S-E2 and the backlight device BL-E2 of the Sample 2 were produced in the same way as the light-transmitting plate example S-E1 and the backlight device BL-E1 of the Sample 1 expect for that the ink material IM-E2 was used instead of the ink material IM-E1.

<Comparative Sample 1>

Preparation of Ink Material IM-C1

An ink material containing only the white ink material (“EG-671 white” available from Teikoku Printing Inks Mfg. Co., Ltd) and not containing the blue ink material (“EG-037 ultramarine” available from Teikoku Printing Inks Mfg. Co., Ltd) was provided as the ink material IM-C1 of the Comparative Sample 1.

Production of Light-Transmitting Plate Sample S-C1 and Backlight Device BL-C1

The light-transmitting plate example S-C1 and the backlight device BL-C1 of the Comparative Sample 1 were produced in the same way as the light-transmitting plate example S-E1 and the backlight device BL-E1 of the Sample 1 expect for that the ink material IM-C1 was used instead of the ink material IM-E1.

<Comparative Sample 2>

Preparation of Ink Material IM-C2

The ink material IM-C2 of the Comparative Sample 2 was prepared in the same way as the ink material IM-E1 of the Sample 1, except that the amount of the blue ink material (“EG-037 ultramarine” available from Teikoku Printing Inks Mfg. Co., Ltd) was changed to 5% by weight.

Production of Light-Transmitting Plate Sample S-C2 and Backlight Device BL-C2

The light-transmitting plate example S-C2 and the backlight device BL-C2 of the Comparative Sample 2 were produced in the same way as the light-transmitting plate example S-E1 and the backlight device BL-E1 of the Sample 1 expect for that the ink material IM-C2 was used instead of the ink material IM-E1.

Measurement of Transmittance and Reflectance

A transmittance and a reflectance were determined for each of the light-transmitting plate examples S-E1, S-E2, S-C1, and S-C2 by using the spectrophotometer CM-5 available from KONICA MINOLTA, INC. The results are indicated in Table 1.

Measurement of Wavelength Distribution and Chromaticity of Transmitted Light TL and Reflected Light RL

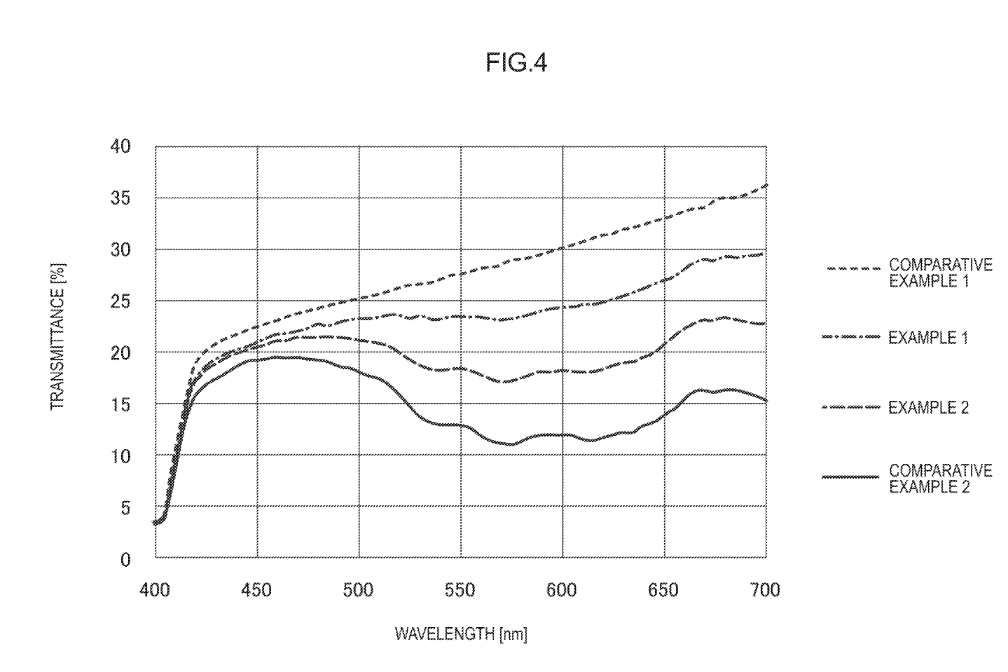

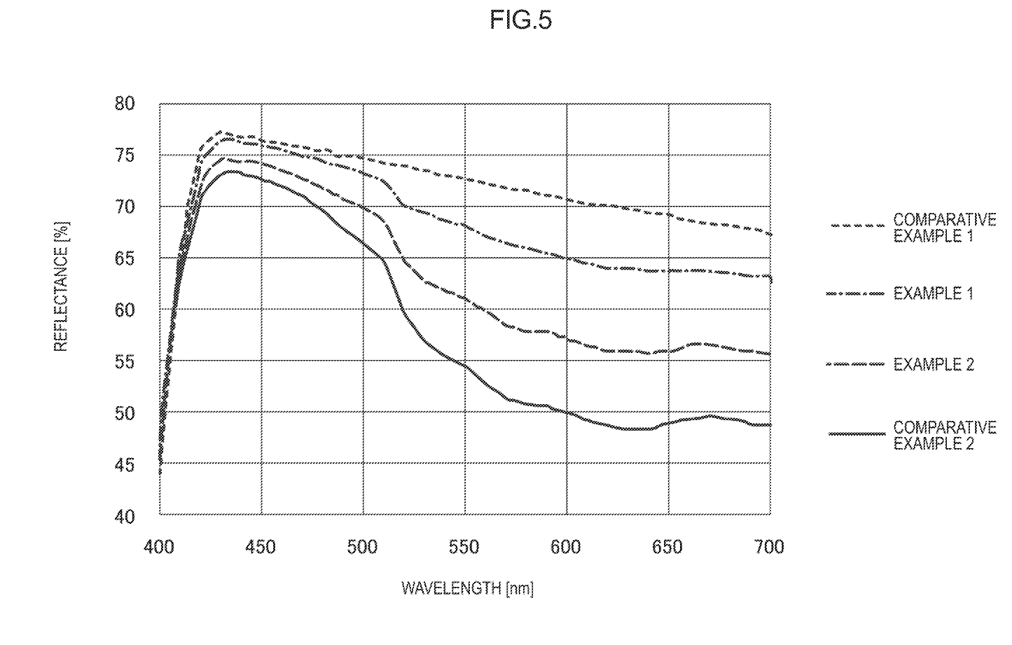

The wavelength distribution was determined for the transmitted light TL passed through the light-transmitting plate examples S-E1, S-E2, S-C1, and S-C2 and for the reflected light RL reflected by the light-transmitting plate examples by using the spectrophotometer CM-5 available from KONICA MINOLTA, INC. The results are indicated in FIG. 4 and FIG. 5.

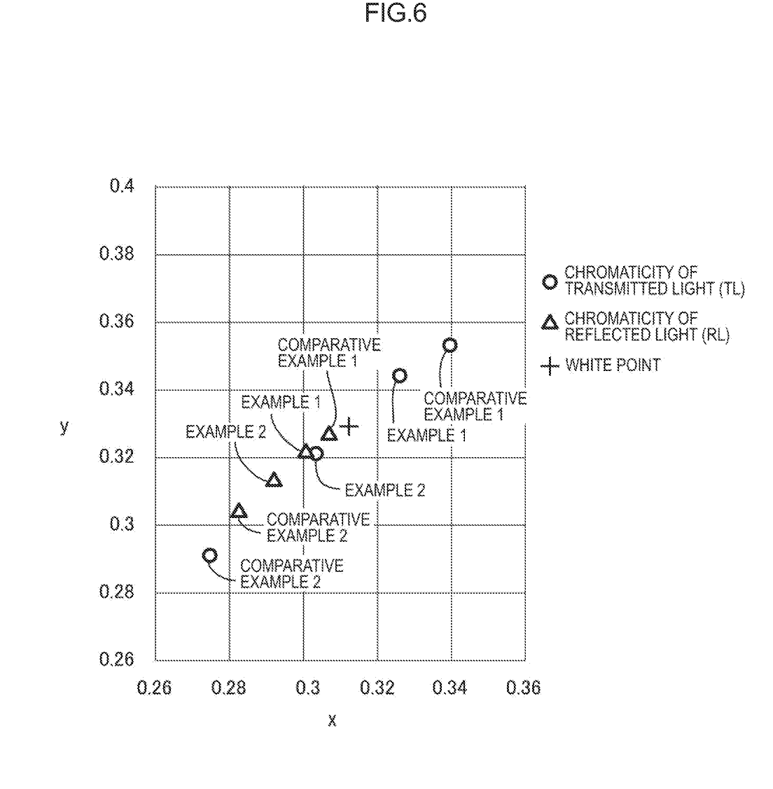

In the same way, the chromaticity was determined for the transmitted light TL passed through the light-transmitting plate examples S-E1, S-E2, S-C1, and S-C2 and for the reflected light RL reflected by the light-transmitting plate examples by using the spectrophotometer CM-5 available from KONICA MINOLTA, INC. The results are indicated in FIG. 6.

Evaluation of Chromaticity Variation

The upper surface (light exit surface 20a) of the prism sheet 41 of each of the backlight devices BL-E1, BL-E2, BL-C1, and BL-C2 was visually checked with the LEDs 21 being turned on to make subjective evaluations of chromaticity variation. The results are indicated in Table 2. In Table 2, “good” indicates that the hue was substantially uniform with almost no chromaticity variation, and “poor” indicates that the hue was non-uniform with chromaticity variation.

TABLE 1

| | AMOUNT | | | |
|---|---|---|---|---|
| | OF BLUE | | | TRANS- |
| | INK | | | MITTANCE + |
| | MATERIAL | TRANS- | REFLEC- | REFLEC- |
| | (% BY | MITTANCE | TANCE | TANCE |
| | WEIGHT) | (%) | (%) | (%) |
| COMPAR- | 0 | 27.95 | 69.84 | 97.79 |
| ATIVE | | | | |
| EXAMPLE 1 | | | | |
| (S-C1) | | | | |
| EXAMPLE 1 | 1 | 23.64 | 86.61 | 92.25 |
| (S-E1) | | | | |
| EXAMPLE 2 | 3 | 18.74 | 62.26 | 81.00 |
| (S-E2) | | | | |
| COMPAR- | 5 | 13.46 | 56.41 | 69.87 |
| ATIVE | | | | |
| EXAMPLE 2 | | | | |
| (S-C2) | | | | |

TABLE 2

| | AMOUNT OF | |
|---|---|---|
| | BLUE INK MATERIAL | CHROMATICITY |
| | (% BY WEIGHT) | VARIATION |
| COMPARATIVE | 0 | POOR |
| EXAMPLE 1 | | |
| (BL-C1) | | |
| EXAMPLE 1 | 1 | GOOD |
| (BL-E1) | | |
| EXAMPLE 2 | 3 | GOOD |
| (BL-E2) | | |
| COMPARATIVE | 5 | POOR |
| EXAMPLE 2 | | |
| (BL-C2) | | |

As can be seen from FIG. 4 and FIG. 6, the transmitted light TL passed through the light-transmitting plate example S-C1 of the Comparative Sample 1, which includes the ink layer only containing the white ink material (EG-671 white), was yellowish, and as can be seen from FIG. 5 and FIG. 6, the reflected light RL reflected thereby was bluish. In the xy chromaticity diagram in FIG. 6, the color is more yellowish as the xy values increase (as xy coordinates of a point approach the upper right end) and the color is more blueish as the xy values decrease (as xy coordinates of a point approach the lower left end). The light-scattering characteristics of titanium oxide make the transmitted light TL yellowish and the reflected light RL bluish. Not only the white ink layer in the Comparative Sample 1, but also the white ink layers in all the other examples contain titanium oxide as the pigment. Thus, in almost all the examples, the transmitted light TL passed through the white ink layer may be yellowish.

Furthermore, as indicated in Table 2, the backlight device BL-C1 of the Comparative Sample 1 had the chromaticity variation. As can be predicted by the evaluation results of the light-transmitting plate example S-C1, the difference in the chromaticity between the transmitted light TL passed through the ink layer and the reflected light RL reflected by the ink layer possibly made the backlight device BL-C1 including the ink layer 42A to have the chromaticity variation.

As indicated in FIG. 4, in the light-transmitting plate example S-E1 of the Sample 1 and the light-transmitting plate example S-E2 of the Sample 2, the transmittance of light in the wavelength range (about 550 nm to about 600 nm) of yellow is appropriately lowered. The light transmittance of the Sample 2, which contains more blue ink material than the Sample 1, is lower than that of the Sample 1. In the Samples 1 and 2, the transmitted light TL was less yellowish due to the blue ink material, and thus, as indicated in FIG. 6, the transmitted light TL in each of the Samples 1 and 2 is marked at coordinates of a point close to the white point, which is reference white. The addition of the blue ink material in a range of 1% by weight or more and 3% by weight or less reduces coloring of the transmitted light TL, resulting in substantially achromatic transmittance distribution.

As indicated in Table 2, chromaticity variation was not observed in the backlight device BL-E1 of the Sample 1 and the backlight device BL-E2 of the Sample 2. As confirmed by the evaluation results of the light-transmitting plate examples S-E1 and S-E2, the good results were probably resulted from that the difference between the chromaticity of the transmitted light TL passed through the ink layer 42A and that of the reflected light RL reflected by the ink layer 42A was reduced by the addition of the proper amount of blue ink material.

As indicated in FIG. 4, in the light-transmitting plate example S-C2 of the Comparative Sample 2, which contains 5% by weight of the blue ink material, the transmittance of the light having a long wavelength is too small, making the transmitted light TL to be relatively bluish. In FIG. 6, coordinates of a point of the transmitted light TL of the Comparative Sample 2 is away from the white point toward the lower left end. This indicates that the transmitted light TL was bluish. As can be seen from Table 1, the Comparative Sample 2 has a lower transmittance than the other examples, and the total of the transmittance and the reflectance, which indicates the light use efficiency, is small. This result implies that the backlight device 20 would have lower brightness if including the light-transmitting plate example of the Comparative Sample 2.

As indicated in Table 2, the chromaticity variation was observed in the backlight device BL-C2 of the Comparative Sample 2. Contrary to the Comparative Sample 1, the bluish transmitted light TL caused the difference in chromaticity between the transmitted light TL and the reflected light RL.

The above results revealed that the ink layer formed of the ink material including titanium oxide and the blue pigment in a proper amount effectively suppress the transmitted light TL passed through the ink layer from becoming yellowish and makes the transmitted light TL to be achromatic. This reduces the difference in chromaticity between the transmitted light TL and the reflected light RL. It was found that the ink layer 42A having the above-described composition reduces the chromaticity variation in the light exit surface 20a of the backlight device 20.

The amount of the blue ink material is preferably 1% by weight or more and 3% by weight or less, when the blue ink material (EG-037 ultramarine) containing the blue pigment is added to the white ink material (EG-671 white) containing titanium oxide as in the above examples. If the amount of the blue ink material falls below the above range, the chromaticity correction is insufficient. If the amount of the blue ink material falls above the above range, the transmitted light TL becomes more bluish, leading to chromaticity variation.

<Sample 3>

Preparation of Ink Material IM-E3

To “EG-671 white” available from Teikoku Printing Inks Mfg. Co., Ltd, which is a white ink material containing titanium oxide, 10% by weight of “Lumina” (registered trademark) Gold 9Y30D, which is a pearl pigment (one example of the second pigment) available from BASF, was added. Then, the ink materials were mixed to prepare the ink material IM-E3 of the Sample 3. Lumina Gold 9Y30D, which is a pearl pigment having an interference color of gold, has a particle diameter of 8 μm to 48 μm and includes a mica core coated with a titanium oxide coating having a thickness of about 40 nm.

Production of Light-Transmitting Plate Sample S-E3 and Backlight Device BL-E3

The light-transmitting plate example S-E3 and the backlight device BL-E3 of the Sample 3 were produced in the same way as the light-transmitting plate example S-E1 and the backlight device BL-E1 of the Sample 1, except that the ink material IM-E3 was used instead of the ink material IM-E1.

<Sample 4>

Preparation of Ink Material IM-E4

The ink material IM-E4 of the Sample 4 was prepared in the same way as the ink material IM-E3 of the Sample 3, except that the amount of the pearl pigment (Lumina Gold 9Y30D) was changed to 20% by weight.

Production of Light-Transmitting Plate Sample S-E4 and Backlight Device BL-E4

The light-transmitting plate example S-E4 and the backlight device BL-E4 of the Sample 4 were produced in the same way as the light-transmitting plate example S-E1 and the backlight device BL-E1 of the Sample 1, except that the ink material IM-E4 was used instead of the ink material IM-E1.

<Sample 5>

Preparation of Ink Material IM-E5

The ink material IM-E5 of the Sample 5 was prepared in the same way as the ink material IM-E3 of the Sample 3, expect for that the amount of the pearl pigment (Lumina Gold 9Y30D) was changed to 30% by weight.

Production of Light-Transmitting Plate Sample S-E5 and Backlight Device BL-E5

The light-transmitting plate example S-E5 and the backlight device BL-E5 of the Sample 5 were produced in the same way as the light-transmitting plate example S-E1 and the backlight device BL-E1 of the Sample 1, except that the ink material IM-E5 was used instead of the ink material IM-E1.

<Comparative Sample 3>

Preparation of Ink Material IM-C3

The ink material IM-C3 of the Comparative Sample 3 was prepared in the same way as the ink material IM-E3 of the Sample 3, expect for that the amount of the pearl pigment (Lumina Gold 9Y30D) was changed to 40% by weight.

Production of Light-Transmitting Plate Sample S-C3 and Backlight Device BL-C3

The light-transmitting plate example S-C3 and the backlight device BL-C3 of the Comparative Sample 3 were produced in the same way as the light-transmitting plate example S-E1 and the backlight device BL-E1 of the Sample 1, except that the ink material IM-C3 was used instead of the ink material IM-E1.

Measurement of Transmittance and Reflectance

A transmittance and a reflectance were determined for each of the light-transmitting plate examples S-E3, S-E4, and S-E5 by using the spectrophotometer CM-5 available from KONICA MINOLTA, INC. The light-transmitting plate example S-C1 was produced again in accordance with the method described in the Comparative Sample 1 and the transmittance and the reflectance thereof were determined in the same way. The results are indicated in Table 3.

The evaluation of the light-transmitting plate example S-C3 of the Comparative Sample 3 was impossible because the ink layer was detached form the acrylic plate. The excessive amount of the pigment probably reduced the adhesion of the ink layer. The results of the Comparative Sample 1 in Table 3 are slightly different from the results of the Comparative Sample 1 in Table 1 probably due to variation between the examples, such as variation in the thickness resulting from individual variability of the screen plates used in the production.

Measurement of Wavelength Distribution and Chromaticity of Transmitted Light TL and Reflected Light RL

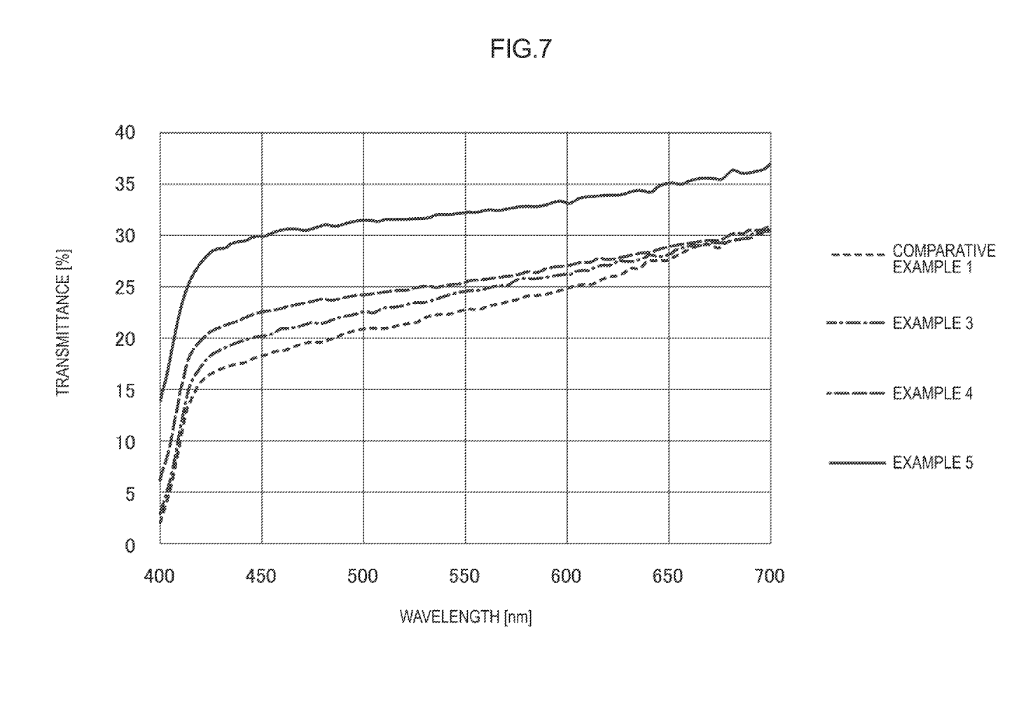

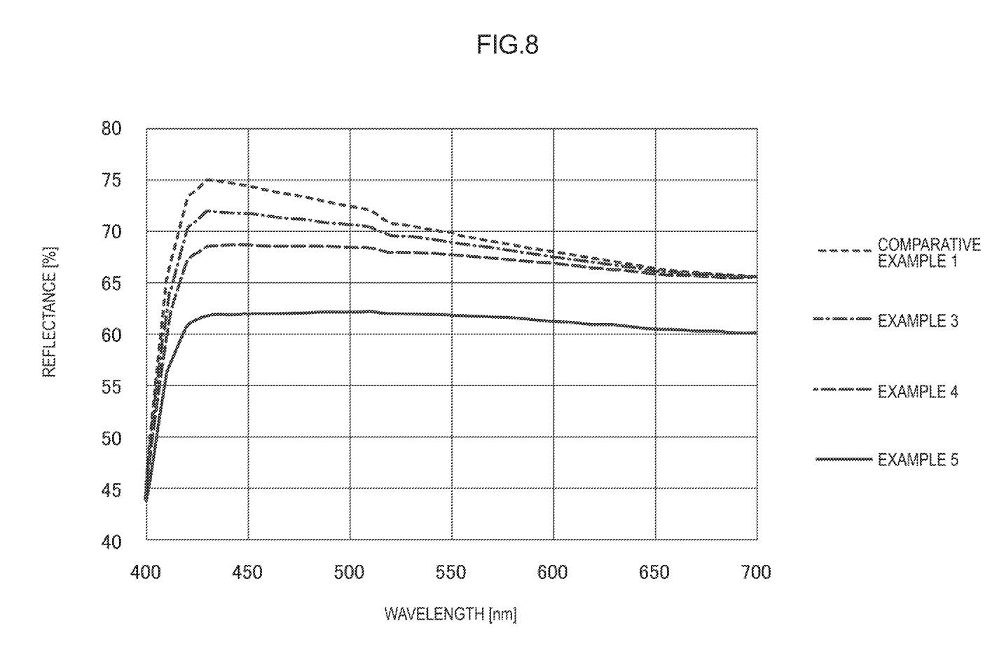

The wavelength distribution was determined for the transmitted light TL passed through the light-transmitting plate examples S-E3, S-E4, and S-E5 and for the reflected light RL reflected by the light-transmitting plate examples by using the spectrophotometer CM-5 available from KONICA MINOLTA, INC. The light-transmitting plate example S-C1 was produced again in accordance with the method described in Comparative Sample 1 and the wavelength distribution and the chromaticity thereof were determined in the same way. The results are indicated in FIG. 7 and FIG. 8.

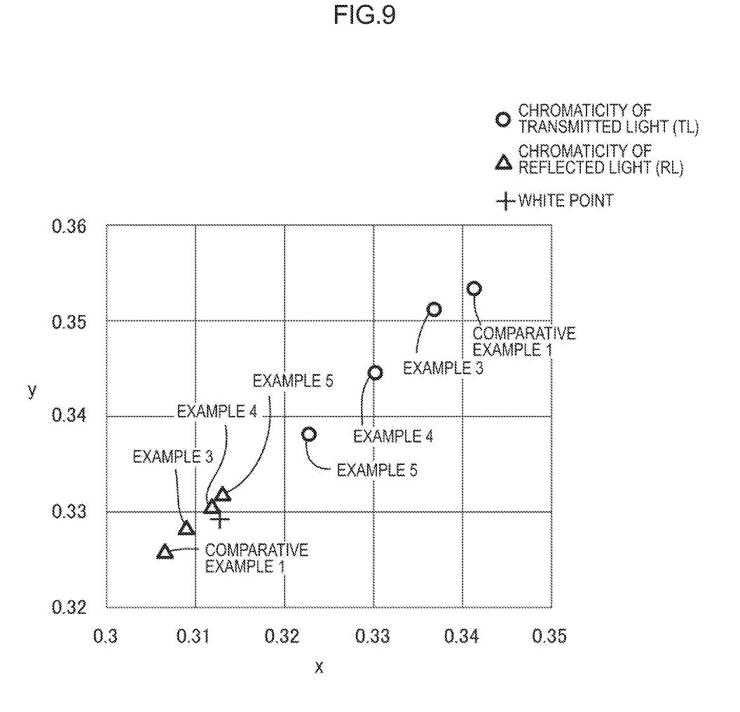

The chromaticity was determined for the transmitted light TL passed through the light-transmitting plate examples S-E3, S-E4, and S-E5 and for the reflected light RL reflected by the light-transmitting plate examples by using the spectrophotometer CM-5 available from KONICA MINOLTA, INC. The results are indicated in FIG. 9.

The evaluation of the light-transmitting plate example S-C3 of the Comparative Sample 3 was impossible because the ink layer was detached from the acrylic plate. The excessive amount of the pigment probably reduced the adhesion of the ink layer. The results of the Comparative Sample 1 in FIG. 7 to FIG. 9 are slightly different from the results of the Comparative Sample 1 in FIG. 4 to FIG. 6 probably due to variation in the production of the examples, for example, as in the variation in Table 3.

Evaluation of Chromaticity Variation

The upper surface (light-emitting surface 20a) of the prism sheet 41 of each of the produced backlight devices BL-E3, BL-E4, and BL-E5 was visually checked with the LEDs 21 being turned on to make subjective evaluation of chromaticity variation. In Table 4, “good” indicates that the hue was substantially uniform with almost no chromaticity variation, “fair” indicates that a little bit of chromaticity variation was found, and “poor” indicates that the hue was non-uniform with chromaticity variation. The backlight device BL-C1 produced again in accordance with the method described in the Comparative Sample 1 was also evaluated in the same way. The results are indicated in Table 4.

TABLE 3

| | AMOUNT | | | TRANS- |
|---|---|---|---|---|
| | OF PEARL | | | MITTANCE + |
| | PIGMENT | TRANS- | REFLEC- | REFLEC- |
| | (% BY | MITTANCE | TANCE | TANCE |
| | WEIGHT) | (%) | (%) | (%) |
| COMPAR- | 0 | 27.85 | 69.87 | 97.72 |
| ATIVE | | | | |
| EXAMPLE 1 | | | | |
| (S-C1) | | | | |
| EXAMPLE 3 | 10 | 29.45 | 68.88 | 98.33 |
| (S-E3) | | | | |
| EXAMPLE 4 | 20 | 30.52 | 67.53 | 98.05 |
| (S-E4) | | | | |
| EXAMPLE 5 | 30 | 37.16 | 61.66 | 98.82 |
| (S-E5) | | | | |
| COMPAR- | 40 | N.D. | N.D. | N.D. |
| ATIVE | | | | |
| EXAMPLE 3 | | | | |
| (S-C3) | | | | |

N.D.: NOT DETERMINED

TABLE 4

| | AMOUNT OF | |
|---|---|---|
| | PEARL PIGMENT | CHROMAICITY |
| | (% BY WEIGHT) | VARIATION |
| COMPARATIVE | 0 | POOR |
| EXAMPLE 1 | | |
| (BL-C1) | | |
| EXAMPLE 3 | 10 | FAIR |
| (BL-E3) | | |
| EXAMPLE 4 | 20 | GOOD |
| (BL-E4) | | |
| EXAMPLE 5 | 30 | GOOD |
| (BL-E5) | | |
| COMPARATIVE | 40 | N.D. |
| EXAMPLE 3 | | |
| (BL-C3) | | |

N.D.: NOT DETERMINED

As indicated in FIG. 7, in each of the light-transmitting plate example S-E3 of Sample 3, the light-transmitting plate example S-E4 of Sample 4, and the light-transmitting plate example S-E5, transmittance of light in the blue wavelength range (about 420 nm to about 500 nm) is appropriately increased. The larger the amount of the pearl pigment, the higher the transmittance of light in the blue wavelength range. This canceled out the yellow hue of the transmitted light TL resulting from titanium oxide, and thus the coordinates of a point of the transmitted light TL of the Samples 3 to 5 in FIG. 9 are closer to the white point, which is reference white, as the amount of the pearl pigment increases. It can be found that the transmitted light TL is less likely to be colored as the amount of the pearl pigment increases, allowing the transmitted light TL to be substantially achromatic. As indicated in FIG. 8, the reflectance of the light in the blue wavelength range (about 420 nm to about 500 nm) is reduced, i.e., the reflected light RL is less likely to be bluish, as the amount of the pearl pigment increases, allowing the reflected light RL to be substantially achromatic as indicated in FIG. 9. As can be seen from Table 3, as the amount of the pearl pigment increases, the reflectance decreases only a little, but the transmittance increases. The light use efficiency represented by the total of the transmittance and the reflectance was improved.

As indicated in Table 4, the backlight device BL-E3 of the Sample 3 had a little bit of chromaticity variation, and the backlight devices BL-E4 and BL-E5 of the Samples 4 and 5 had no chromaticity variation. The good results of the Samples 3 to 5 are probably due to the pearl pigment. As confirmed by the light-transmitting plate examples S-E3, S-E4, and S-E5, the pearl pigments suppressed coloring of the transmitted light TL and the reflected light RL, reducing the difference between the chromaticity of the transmitted light TL passed through the ink layer 42A and that of the reflected light RL reflected by the ink layer 42A.

The evaluation of the light-transmitting plate example S-C3 of the Comparative Sample 3, which includes the ink layer containing 40% by weight of the pearl pigment was impossible, because the ink material IM-C3 was not able to be properly applied onto the base (acrylic plate) and the ink layer was detached from the ink layer.

The above results revealed that the ink layer formed of the ink material including the pearl pigment effectively suppressed coloring of the transmitted light TL passed through the ink layer and the reflected light RL reflected by the ink layer, allowing the transmitted light TL and the reflected light RL to be substantially achromatic. This reduces the difference between the chromaticity of the transmitted light TL and that of the reflected light RL. The ink layer 42A of the backlight device 20 formed as above reduces the chromaticity variation in the backlight device 20.

<Comparative Sample 4>

Production of Backlight Device BL-C4

The backlight device BL-C4 of the Comparative Sample 4 was produced in the same way as the backlight device BL-E1 of the Sample 1, except that the ink layer 42A was not formed.

Evaluation of Chromaticity Variation

The upper surface (light exit surface 20a) of the prism sheet 41 of each of the backlight devices BL-C4 of the Comparative Sample 4, BL-E1 of the Sample 1, and BL-E4 of the Sample 4 was visually checked with the LEDs 21 being turned on to make subjective evaluations of chromaticity variation. In Table 5, “good” indicates that the hue was substantially uniform with almost no chromaticity variation, and “poor” indicates that the hue was non-uniform with chromaticity variation.

Measurement of Brightness

The brightness of the upper surface (light emitting surface 20a) of the prism sheet 41 was determined for the backlight device BL-C4 of the Comparative Sample 4, the backlight device BL-E1 of the Sample 1, and the backlight device BL-E4 of the Sample 4 with the LEDs 21 being turned on by using the spectroradiometer CS-2000 available from KONICA MINOLTA, INC. The results are indicated in

TABLE 5

| | | | AVERAGE |
|---|---|---|---|
| | | CHROMAICITY | BRIGHTNESS |
| | INK MATERIAL | VARIATION | (cd/m²) |
| COMPAR- | (NO INK LAYER) | POOR | 8000 |
| ATIVE | | | |
| EXAMPLE 4 | | | |
| (BL-C4) | | | |
| EXAMPLE 1 | IM-E1 | GOOD | 6500 |
| (BL-E1) | (1% BY WEIGHT | | |
| | OF BLUE INK | | |
| | MATERIAL) | | |
| EXAMPLE 4 | IM-E4 | GOOD | 8000 |
| (BL-E4) | (20% BY WEIGHT | | |
| | OF PEARL | | |
| | PIGMENT) | | |

As can be seen from Table 5, the backlight device BL-E1 of the Sample 1, which includes the blue pigment to eliminate the chromaticity variation, has enough brightness for practical use, but the brightness is lower than the other backlight devices. As can be seen from Table 1, both the transmittance and the reflectance decrease as the amount of the blue pigment increases.

In contract, the backlight device BL-E4 of the Sample 4, which includes the pearl pigment to eliminate the chromaticity variation, has substantially the same level of high brightness as the backlight device BL-C4 of the Comparative Sample 4 not including the ink layer. As can be seen from Table 3, the pearl pigment basically does not absorb light, and the color is corrected based on the light interference, and thus the addition of the pearl pigment does not change the total of the transmittance and the reflectance (light use efficiency).

The above results indicate that, to keep the high brightness of the backlight device 20, as the pigment that gives a blue hue to the transmitted light TL, the pearl pigment is more preferably included in the ink layer 42A than the blue pigment.

1. A lighting device comprising:
a light source; and
an ink layer configured to transmit and reflect light from the light source, the ink layer containing a white pigment as a first pigment and a second pigment that gives a blue hue to the light passed therethrough.

2. The lighting device according to claim 1, further comprising a diffusing plate configured to diffuse light from the light source therein and allow the light to exit therefrom toward a side away from the light source, wherein
the ink layer is disposed on the diffusing plate.

3. The lighting device according to claim 1, wherein the second pigment is a blue pigment.

4. The lighting device according to claim 1, wherein the second pigment includes a light-transmitting core coated with a light-transmitting coating, the light-transmitting coating being formed of a metal compound and having a refractive index different from that of the core.

5. The lighting device according to claim 4, wherein the light-transmitting coating has a thickness of 30 nm or more and 80 nm or less.

6. The lighting device according to claim 4, wherein the second pigment has a particle diameter of 1 μm or more and 50 μm or less.

7. An image display device comprising the lighting device according to claim 1.
